(19) United States
(12) Patent Application Publication
(10) Pub. No.: US 2005/0028170 A1
(43) Pub. Date: Feb. 3, 2005

(54) Method and system for automatically running a backup process

(76) Inventor: Steffan Bansemer, Berlin (DE)

Correspondence Address: Steffan Bansemer, Regattastr. 60, Berlin, 12527, DE

(21) Appl. No.: 10/628,113

(22) Filed: Jul. 28, 2003

(51) Int. Cl. G06F 9/00

(52) U.S. Cl. 719/318

(57) ABSTRACT

A method and system for automatically running a backup process upon detection of the shutdown, user logoff or reboot of a computer system are provided. Common operating systems are sending a notification message to all active applications when the computer session is finished. After receiving this message from the operating system a backup application starts to execute predefined backup tasks. Thus, the running of the predefined backup tasks is performed without any action being required on the part of a user.

### FIELD OF THE INVENTION

This invention relates generally to computer systems and, more particularly, to a method and system in a computer system for automatically running a backup process upon detection of shutdown, user logoff or reboot of a computer system.

### BACKGROUND OF THE INVENTION

Backup applications are running the execution of backup tasks when a user manually initiated the process or when the execution was scheduled for a specific date and time. But if you want to have up to date backups of a computer system's data the shutdown, user logoff or reboot is the best time to act. These events do indicate a finished computer session and a backup application now can back up all modified files of that session to prevent the loss of important data and keep backups up to date. This invention provides an easy way to run the execution of a backup process without any action being required on the part of a user.

### SUMMARY OF THE INVENTION

According to the present invention, this method and system runs automatically a backup process upon detection of the shutdown, user logoff or reboot of a computer system. The method uses operating systems notification about these events to run predefined backup tasks. After execution of the backup tasks the backup application reinitiates the according process that was interrupted to backup the computer system's data.

1. A method in a computer system for automatically executing predefined backup tasks upon receiving a message from the operating system that notifies applications about finishing the computer session, the method comprising the computer-implemented steps of:
loading the computer program into memory of the computer system;
waiting for the operating system's message that the computer system will shutdown; and
when this specific message was received the computer program interrupts the process of the system's shutdown;
the computer program executes the predefined tasks to back up data of the computer system;
when these backup tasks are executed the computer program calls the operating systems application programming interface to initiate once more the shutdown of the computer system;
the computer program does no longer interrupt shutting down the computer system;

2. The method of claim 1 wherein the operating system's message is a notification about a user logoff from the computer system and the backup application initiates once more the logoff after execution of the backup tasks.

3. The method of claim 1 wherein the operating system's message is a notification about rebooting the computer system and the backup application initiates once more the system reboot after execution of the backup tasks.
